(19) United States
(12) Patent Application Publication
(10) Pub. No.: US 2024/0244249 A1
(43) Pub. Date: Jul. 18, 2024

(54) METHOD, APPARATUS, AND MEDIUM FOR POINT CLOUD CODING

(71) Applicants: Beijing Bytedance Network Technology Co., Ltd., Beijing (CN); Bytedance Inc., Los Angeles, CA (US)

(72) Inventors: Wenyi WANG, Beijing (CN); Kai ZHANG, Los Angeles, CA (US); Li ZHANG, Los Angeles, CA (US)

(21) Appl. No.: 18/622,545

(22) Filed: Mar. 29, 2024

Related U.S. Application Data
(63) Continuation of application No. PCT/CN2022/121836, filed on Sep. 27, 2022.

(30) Foreign Application Priority Data
Sep. 30, 2021 (WO) PCT/CN2021/122408

(51) Int. Cl. H04N 19/51; H04N 19/124; H04N 19/184

(52) U.S. Cl. CPC H04N 19/51; H04N 19/124; H04N 19/184

(57) ABSTRACT

Embodiments of the present disclosure provide a method for point cloud coding. The method comprises: obtaining, during a conversion between a current frame of a point cloud sequence and a bit-stream of the point cloud sequence, motion information of the current frame; determining a binarized representation of the motion information, the binarized representation at least reflecting an absolute value of the motion information; and performing the conversion based on the binarized representation of the motion information. Compared with the conventional solution, the proposed method can advantageously improve the accuracy of motion information coding and coding quality.

### CROSS-REFERENCE TO RELATED APPLICATIONS

This application is a continuation of International Application No. PCT/CN2022/121836, filed on Sep. 27, 2022, which claims the benefit of International Application No. PCT/CN2021/122408 filed on Sep. 30, 2021. The entire contents of these applications are hereby incorporated by reference in their entireties.

### FIELD

Embodiments of the present disclosure relates generally to point cloud coding techniques, and more particularly, to motion information coding for point cloud coding.

### BACKGROUND

A point cloud is a collection of individual data points in a three-dimensional (3D) plane with each point having a set coordinate on the X, Y, and Z axes. Thus, a point cloud may be used to represent the physical content of the three-dimensional space. Point clouds have shown to be a promising way to represent 3D visual data for a wide range of immersive applications, from augmented reality to autonomous cars.

Point cloud coding standards have evolved primarily through the development of the well-known MPEG organization. MPEG, short for Moving Picture Experts Group, is one of the main standardization groups dealing with multimedia. In 2017, the MPEG 3D Graphics Coding group (3DG) published a call for proposals (CFP) document to start to develop point cloud coding standard. The final standard will consist in two classes of solutions. Video-based Point Cloud Compression (V-PCC or VPCC) is appropriate for point sets with a relatively uniform distribution of points. Geometry-based Point Cloud Compression (G-PCC or GPCC) is appropriate for more sparse distributions. However, coding efficiency of conventional point cloud coding techniques is generally expected to be further improved.

### SUMMARY

In a first aspect, a method for point cloud coding is proposed. The method comprises: obtaining, during a conversion between a current frame of a point cloud sequence and a bitstream of the point cloud sequence, motion information of the current frame; determining a binarized representation of the motion information, the binarized representation at least reflecting an absolute value of the motion information; and performing the conversion based on the binarized representation of the motion information.

The method in accordance with the first aspect of the present disclosure determines a binarized representation of the motion information to reflect an absolute value of the motion information. Compared with the conventional solution where the negative value of motion information is binarized with a complement format, the proposed method can advantageously enable binarizing the motion information according to the distribution probability, and thus improve the efficiency of motion information coding and coding quality.

In a second aspect, an apparatus for processing point cloud data is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, a non-transitory computer-readable recording medium is proposed. The non-transitory computer-readable recording medium stores a bitstream of a point cloud sequence which is generated by a method performed by a point cloud processing apparatus. The method comprises: obtaining motion information of a current frame of the point cloud sequence; determining a binarized representation of the motion information, the binarized representation at least reflecting an absolute value of the motion information; and generating the bitstream based on the binarized representation of the motion information.

In a fifth aspect, a method for storing a bitstream of a point cloud sequence is proposed. The method comprises: obtaining motion information of a current frame of the point cloud sequence; determining a binarized representation of the motion information, the binarized representation at least reflecting an absolute value of the motion information; generating the bitstream based on the binarized representation of the motion information; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 is a block diagram that illustrates an example point cloud coding system that may utilize the techniques of the present disclosure;

FIG. 2 illustrates a block diagram that illustrates an example point cloud encoder, in accordance with some embodiments of the present disclosure;

FIG. 3 illustrates a block diagram that illustrates an example point cloud decoder, in accordance with some embodiments of the present disclosure;

FIG. 4 is a schematic diagram illustrating an example of the improved motion parameters coding;

FIG. 5 is a schematic diagram illustrating an example of the improved motion parameters coding;

FIG. 6 illustrates a flowchart of a method for point cloud coding in accordance with some embodiments of the present disclosure; and

FIG. 7 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

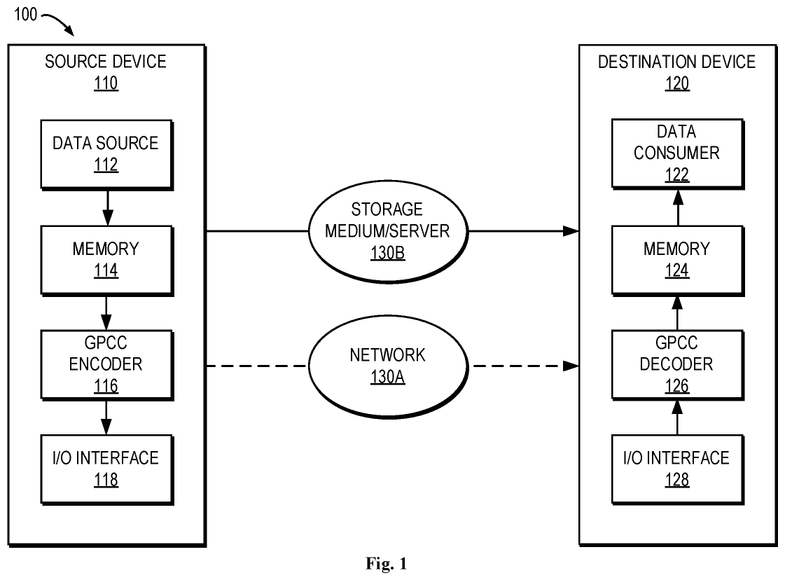

FIG. 1 is a block diagram that illustrates an example point cloud coding system 100 that may utilize the techniques of the present disclosure. As shown, the point cloud coding system 100 may include a source device 110 and a destination device 120. The source device 110 can be also referred to as a point cloud encoding device, and the destination device 120 can be also referred to as a point cloud decoding device. In operation, the source device 110 can be configured to generate encoded point cloud data and the destination device 120 can be configured to decode the encoded point cloud data generated by the source device 110. The techniques of this disclosure are generally directed to coding (encoding and/or decoding) point cloud data, i.e., to support point cloud compression. The coding may be effective in compressing and/or decompressing point cloud data.

Source device 100 and destination device 120 may comprise any of a wide range of devices, including desktop computers, notebook (i.e., laptop) computers, tablet computers, set-top boxes, telephone handsets such as smartphones and mobile phones, televisions, cameras, display devices, digital media players, video gaming consoles, video streaming devices, vehicles (e.g., terrestrial or marine vehicles, spacecraft, aircraft, etc.), robots, LIDAR devices, satellites, extended reality devices, or the like. In some cases, source device 100 and destination device 120 may be equipped for wireless communication.

The source device 100 may include a data source 112, a memory 114, a GPCC encoder 116, and an input/output (I/O) interface 118. The destination device 120 may include an input/output (I/O) interface 128, a GPCC decoder 126, a memory 124, and a data consumer 122. In accordance with this disclosure, GPCC encoder 116 of source device 100 and GPCC decoder 126 of destination device 120 may be configured to apply the techniques of this disclosure related to point cloud coding. Thus, source device 100 represents an example of an encoding device, while destination device 120 represents an example of a decoding device. In other examples, source device 100 and destination device 120 may include other components or arrangements. For example, source device 100 may receive data (e.g., point cloud data) from an internal or external source. Likewise, destination device 120 may interface with an external data consumer, rather than include a data consumer in the same device.

In general, data source 112 represents a source of point cloud data (i.e., raw, unencoded point cloud data) and may provide a sequential series of “frames” of the point cloud data to GPCC encoder 116, which encodes point cloud data for the frames. In some examples, data source 112 generates the point cloud data. Data source 112 of source device 100 may include a point cloud capture device, such as any of a variety of cameras or sensors, e.g., one or more video cameras, an archive containing previously captured point cloud data, a 3D scanner or a light detection and ranging (LIDAR) device, and/or a data feed interface to receive point cloud data from a data content provider. Thus, in some examples, data source 112 may generate the point cloud data based on signals from a LIDAR apparatus. Alternatively or additionally, point cloud data may be computer-generated from scanner, camera, sensor or other data. For example, data source 112 may generate the point cloud data, or produce a combination of live point cloud data, archived point cloud data, and computer-generated point cloud data. In each case, GPCC encoder 116 encodes the captured, pre-captured, or computer-generated point cloud data. GPCC encoder 116 may rearrange frames of the point cloud data from the received order (sometimes referred to as “display order”) into a coding order for coding. GPCC encoder 116 may generate one or more bitstreams including encoded point cloud data. Source device 100 may then output the encoded point cloud data via I/O interface 118 for reception and/or retrieval by, e.g., I/O interface 128 of destination device 120. The encoded point cloud data may be transmitted directly to destination device 120 via the I/O interface 118 through the network 130A. The encoded point cloud data may also be stored onto a storage medium/server 130B for access by destination device 120.

Memory 114 of source device 100 and memory 124 of destination device 120 may represent general purpose memories. In some examples, memory 114 and memory 124 may store raw point cloud data, e.g., raw point cloud data from data source 112 and raw, decoded point cloud data from GPCC decoder 126. Additionally or alternatively, memory 114 and memory 124 may store software instructions executable by, e.g., GPCC encoder 116 and GPCC decoder 126, respectively. Although memory 114 and memory 124 are shown separately from GPCC encoder 116 and GPCC decoder 126 in this example, it should be understood that GPCC encoder 116 and GPCC decoder 126 may also include internal memories for functionally similar or equivalent purposes. Furthermore, memory 114 and memory 124 may store encoded point cloud data, e.g., output from GPCC encoder 116 and input to GPCC decoder 126. In some examples, portions of memory 114 and memory 124 may be allocated as one or more buffers, e.g., to store raw, decoded, and/or encoded point cloud data. For instance, memory 114 and memory 124 may store point cloud data.

I/O interface 118 and I/O interface 128 may represent wireless transmitters/receivers, modems, wired networking components (e.g., Ethernet cards), wireless communication components that operate according to any of a variety of IEEE 802.11 standards, or other physical components. In examples where I/O interface 118 and I/O interface 128 comprise wireless components, I/O interface 118 and I/O interface 128 may be configured to transfer data, such as encoded point cloud data, according to a cellular communication standard, such as 4G, 4G-LTE (Long-Term Evolution), LTE Advanced, 5G, or the like. In some examples where I/O interface 118 comprises a wireless transmitter, I/O interface 118 and I/O interface 128 may be configured to transfer data, such as encoded point cloud data, according to other wireless standards, such as an IEEE 802.11 specification. In some examples, source device 100 and/or destination device 120 may include respective system-on-a-chip (SoC) devices. For example, source device 100 may include an SoC device to perform the functionality attributed to GPCC encoder 116 and/or I/O interface 118, and destination device 120 may include an SoC device to perform the functionality attributed to GPCC decoder 126 and/or I/O interface 128.

The techniques of this disclosure may be applied to encoding and decoding in support of any of a variety of applications, such as communication between autonomous vehicles, communication between scanners, cameras, sensors and processing devices such as local or remote servers, geographic mapping, or other applications.

I/O interface 128 of destination device 120 receives an encoded bitstream from source device 110. The encoded bitstream may include signaling information defined by GPCC encoder 116, which is also used by GPCC decoder 126, such as syntax elements having values that represent a point cloud. Data consumer 122 uses the decoded data. For example, data consumer 122 may use the decoded point cloud data to determine the locations of physical objects. In some examples, data consumer 122 may comprise a display to present imagery based on the point cloud data.

GPCC encoder 116 and GPCC decoder 126 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of GPCC encoder 116 and GPCC decoder 126 may be included in one or more encoders or decoders, either of which may be integrated as part of a combined encoder/decoder (CODEC) in a respective device. A device including GPCC encoder 116 and/or GPCC decoder 126 may comprise one or more integrated circuits, microprocessors, and/or other types of devices.

GPCC encoder 116 and GPCC decoder 126 may operate according to a coding standard, such as video point cloud compression (VPCC) standard or a geometry point cloud compression (GPCC) standard. This disclosure may generally refer to coding (e.g., encoding and decoding) of frames to include the process of encoding or decoding data. An encoded bitstream generally includes a series of values for syntax elements representative of coding decisions (e.g., coding modes).

A point cloud may contain a set of points in a 3D space, and may have attributes associated with the point. The attributes may be color information such as R, G, B or Y, Cb, Cr, or reflectance information, or other attributes. Point clouds may be captured by a variety of cameras or sensors such as LIDAR sensors and 3D scanners and may also be computer-generated. Point cloud data are used in a variety of applications including, but not limited to, construction (modeling), graphics (3D models for visualizing and animation), and the automotive industry (LIDAR sensors used to help in navigation).

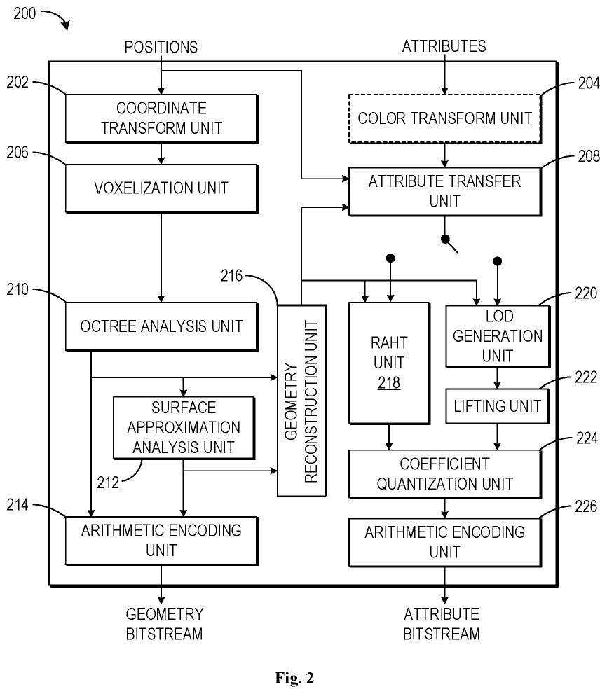

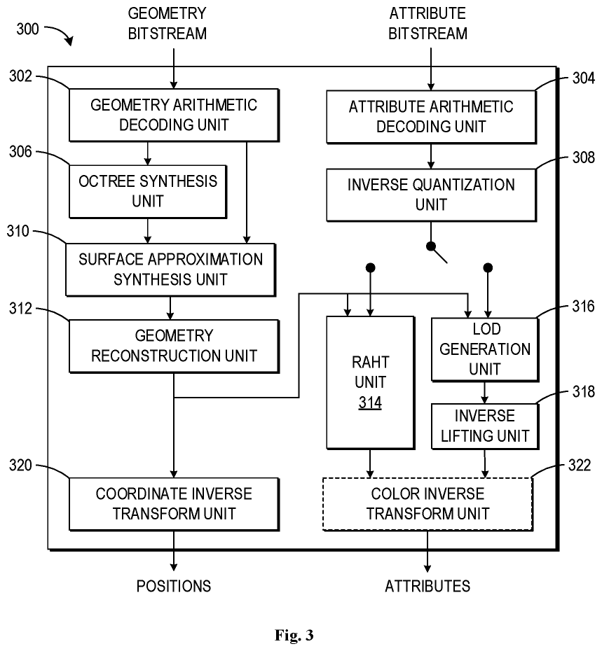

FIG. 2 is a block diagram illustrating an example of a GPCC encoder 200, which may be an example of the GPCC encoder 116 in the system 100 illustrated in FIG. 1, in accordance with some embodiments of the present disclosure. FIG. 3 is a block diagram illustrating an example of a GPCC decoder 300, which may be an example of the GPCC decoder 126 in the system 100 illustrated in FIG. 1, in accordance with some embodiments of the present disclosure.

In both GPCC encoder 200 and GPCC decoder 300, point cloud positions are coded first. Attribute coding depends on the decoded geometry. In FIG. 2 and FIG. 3, the region adaptive hierarchical transform (RAHT) unit 218, surface approximation analysis unit 212, RAHT unit 314 and surface approximation synthesis unit 310 are options typically used for Category 1 data. The level-of-detail (LOD) generation unit 220, lifting unit 222, LOD generation unit 316 and inverse lifting unit 318 are options typically used for Category 3 data. All the other units are common between Categories 1 and 3.

For Category 3 data, the compressed geometry is typically represented as an octree from the root all the way down to a leaf level of individual voxels. For Category 1 data, the compressed geometry is typically represented by a pruned octree (i.e., an octree from the root down to a leaf level of blocks larger than voxels) plus a model that approximates the surface within each leaf of the pruned octree. In this way, both Category 1 and 3 data share the octree coding mechanism, while Category 1 data may in addition approximate the voxels within each leaf with a surface model. The surface model used is a triangulation comprising 1-10 triangles per block, resulting in a triangle soup. The Category 1 geometry codec is therefore known as the Trisoup geometry codec, while the Category 3 geometry codec is known as the Octree geometry codec.

In the example of FIG. 2, GPCC encoder 200 may include a coordinate transform unit 202, a color transform unit 204, a voxelization unit 206, an attribute transfer unit 208, an octree analysis unit 210, a surface approximation analysis unit 212, an arithmetic encoding unit 214, a geometry reconstruction unit 216, an RAHT unit 218, a LOD generation unit 220, a lifting unit 222, a coefficient quantization unit 224, and an arithmetic encoding unit 226.

As shown in the example of FIG. 2, GPCC encoder 200 may receive a set of positions and a set of attributes. The positions may include coordinates of points in a point cloud. The attributes may include information about points in the point cloud, such as colors associated with points in the point cloud.

Coordinate transform unit 202 may apply a transform to the coordinates of the points to transform the coordinates from an initial domain to a transform domain. This disclosure may refer to the transformed coordinates as transform coordinates. Color transform unit 204 may apply a transform to convert color information of the attributes to a different domain. For example, color transform unit 204 may convert color information from an RGB color space to a YCbCr color space.

Furthermore, in the example of FIG. 2, voxelization unit 206 may voxelize the transform coordinates. Voxelization of the transform coordinates may include quantizing and removing some points of the point cloud. In other words, multiple points of the point cloud may be subsumed within a single “voxel,” which may thereafter be treated in some respects as one point. Furthermore, octree analysis unit 210 may generate an octree based on the voxelized transform coordinates. Additionally, in the example of FIG. 2, surface approximation analysis unit 212 may analyze the points to potentially determine a surface representation of sets of the points. Arithmetic encoding unit 214 may perform arithmetic encoding on syntax elements representing the information of the octree and/or surfaces determined by surface approximation analysis unit 212. GPCC encoder 200 may output these syntax elements in a geometry bitstream.

Geometry reconstruction unit 216 may reconstruct transform coordinates of points in the point cloud based on the octree, data indicating the surfaces determined by surface approximation analysis unit 212, and/or other information. The number of transform coordinates reconstructed by geometry reconstruction unit 216 may be different from the original number of points of the point cloud because of voxelization and surface approximation. This disclosure may refer to the resulting points as reconstructed points. Attribute transfer unit 208 may transfer attributes of the original points of the point cloud to reconstructed points of the point cloud data.

Furthermore, RAHT unit 218 may apply RAHT coding to the attributes of the reconstructed points. Alternatively or additionally, LOD generation unit 220 and lifting unit 222 may apply LOD processing and lifting, respectively, to the attributes of the reconstructed points. RAHT unit 218 and lifting unit 222 may generate coefficients based on the attributes. Coefficient quantization unit 224 may quantize the coefficients generated by RAHT unit 218 or lifting unit 222. Arithmetic encoding unit 226 may apply arithmetic coding to syntax elements representing the quantized coefficients. GPCC encoder 200 may output these syntax elements in an attribute bitstream.

In the example of FIG. 3, GPCC decoder 300 may include a geometry arithmetic decoding unit 302, an attribute arithmetic decoding unit 304, an octree synthesis unit 306, an inverse quantization unit 308, a surface approximation synthesis unit 310, a geometry reconstruction unit 312, a RAHT unit 314, a LOD generation unit 316, an inverse lifting unit 318, a coordinate inverse transform unit 320, and a color inverse transform unit 322.

GPCC decoder 300 may obtain a geometry bitstream and an attribute bitstream. Geometry arithmetic decoding unit 302 of decoder 300 may apply arithmetic decoding (e.g., CABAC or other type of arithmetic decoding) to syntax elements in the geometry bitstream. Similarly, attribute arithmetic decoding unit 304 may apply arithmetic decoding to syntax elements in attribute bitstream.

Octree synthesis unit 306 may synthesize an octree based on syntax elements parsed from geometry bitstream. In instances where surface approximation is used in geometry bitstream, surface approximation synthesis unit 310 may determine a surface model based on syntax elements parsed from geometry bitstream and based on the octree.

Furthermore, geometry reconstruction unit 312 may perform a reconstruction to determine coordinates of points in a point cloud. Coordinate inverse transform unit 320 may apply an inverse transform to the reconstructed coordinates to convert the reconstructed coordinates (positions) of the points in the point cloud from a transform domain back into an initial domain.

Additionally, in the example of FIG. 3, inverse quantization unit 308 may inverse quantize attribute values. The attribute values may be based on syntax elements obtained from attribute bitstream (e.g., including syntax elements decoded by attribute arithmetic decoding unit 304).

Depending on how the attribute values are encoded, RAHT unit 314 may perform RAHT coding to determine, based on the inverse quantized attribute values, color values for points of the point cloud. Alternatively, LOD generation unit 316 and inverse lifting unit 318 may determine color values for points of the point cloud using a level of detail-based technique.

Furthermore, in the example of FIG. 3, color inverse transform unit 322 may apply an inverse color transform to the color values. The inverse color transform may be an inverse of a color transform applied by color transform unit 204 of encoder 200. For example, color transform unit 204 may transform color information from an RGB color space to a YCbCr color space. Accordingly, color inverse transform unit 322 may transform color information from the YCbCr color space to the RGB color space.

The various units of FIG. 2 and FIG. 3 are illustrated to assist with understanding the operations performed by encoder 200 and decoder 300. The units may be implemented as fixed-function circuits, programmable circuits, or a combination thereof. Fixed-function circuits refer to circuits that provide particular functionality and are preset on the operations that can be performed. Programmable circuits refer to circuits that can be programmed to perform various tasks and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to GPCC or other specific point cloud codecs, the disclosed techniques are applicable to other point cloud coding technologies also. Furthermore, while some embodiments describe point cloud coding steps in detail, it will be understood that corresponding steps decoding that undo the coding will be implemented by a decoder.

### 1. Summary

This disclosure is related to point cloud coding technologies. Specifically, it is related to motion parameter coding, such as global motion and local motion mode in inter prediction. The ideas may be applied individually or in various combination, to any point cloud coding standard or non-standard point cloud codec, e.g., the being-developed Geometry based Point Cloud Compression (G-PCC).

### 2. Abbreviations

G-PCC Geometry based Point Cloud Compression
MPEG Moving Picture Experts Group
3DG 3D Graphics Coding Group
CFP Call For Proposal
V-PCC Video-based Point Cloud Compression
InterEM Inter Prediction Exploration Model
EGk k-th order Exp-Golomb

### 3. Background

Point cloud coding standards have evolved primarily through the development of the well-known MPEG organization. MPEG, short for Moving Picture Experts Group, is one of the main standardization groups dealing with multimedia. In 2017, the MPEG 3D Graphics Coding group (3DG) published a call for proposals (CFP) document to start to develop point cloud coding standard. The final standard will consist in two classes of solutions. Video-based Point Cloud Compression (V-PCC) is appropriate for point sets with a relatively uniform distribution of points. Geometry-based Point Cloud Compression (G-PCC) is appropriate for more sparse distributions. Both V-PCC and G-PCC support the coding and decoding for single point cloud and point cloud sequence. In one point cloud, there may be geometry information and attribute information. Geometry information is used to describe the geometry locations of the data points. Attribute information is used to record some details of the data points, such as textures, normal vectors, reflections and so on. Point cloud codec can process the various information in different ways. Usually there are many optional tools in the codec to support the coding and decoding of geometry information and attribute information respectively.

### 3.1 Inter Prediction Exploration Model

An important tool in source coding is inter prediction technology which can effective eliminate temporal redundancy. For exploring the performance of inter prediction tool, the MPEG 3D Graphics Coding group established inter prediction exploration model, referred to InterEM. The InterEM will be an important reference model which is used to explore the technology direction of point cloud compression in next version geometry-based point cloud compression standard. In current latest InterEM (InterEMv3.0), to eliminate temporal redundancy, the InterEM will perform motion compensation to previously encoded/decoded point cloud frame (called as reference point cloud). Then the compensated reference point cloud will be used to predict current encoding/decoding point cloud.

### 3.2 Road and Objects Points Classification

Point cloud data, used in automotive, smart-city infrastructures, etc. is typically captured by LIDAR sensors attached to moving vehicles. Infrastructure, such as road and buildings, will be moved by the direction of the vehicle. However, road and objects within the point cloud have different motion. This is because objects like buildings, poles, etc. exist vertically in the direction of the vehicle's progress, but roads exist horizontally. The movement of the point corresponding to the road is primarily formed by the scanning frequency of the LIDAR sensor. However, since the plane of the object is formed vertically to the direction of the vehicle's progress, the position of the point in the object changes as direction of the vehicle's progress. Considering the situation above, the motion compensation is performed by dividing the point cloud into road and objects. To be specific, the reference point cloud will be segmented into road and objects firstly. Then just the objects will be performed motion compensation.

In general, objects exist above or below the road. Based on this observation, InterEM derive two thresholds named top_threshold and bottom_threshold (bottom_threshold<top_threshold) based on the height of points. If the height of a point is smaller than bottom_threshold or greater than top_threshold, it is labeled as belonging to an object, otherwise, it is classified as road. The segment thresholds top_threshold and bottom_threshold will be signaled.

### 3.3 Global Motion Compensation

After the points in the reference point cloud are classified into the road and objects, only the points with object label are considered in the global motion compensation process. In InterEM, the global motion compensation will be performed using the matrix formulation P′=RP+T. The matrix formulation can be expressed as follows:

$$[ \begin{matrix}{x}^{′} \\ {y}^{′} \\ {z}^{′}\end{matrix} ] = [ \begin{matrix}{r}_{11} & {r}_{12} & {r}_{13} \\ {r}_{21} & {r}_{22} & {r}_{23} \\ {r}_{3 I} & {r}_{32} & {r}_{33}\end{matrix} ] [ \begin{matrix}x \\ y \\ z\end{matrix} ] + [ \begin{matrix}{t}_{1} \\ {t}_{2} \\ {t}_{3}\end{matrix} ] \qquad ( 3 - 1 )$$

It can be solid transformations implying translations and rotations or even non-solid transformations. In case the 3×3 matrix R is identity matrix, one obtains a 3D translation along the vector T. In case the matrix is orthonormal, one obtains a solid transformation without local deformation of the set of points. The motion matrix R and T can be derived by either performing motion estimation or computed externally. The compensated reference point cloud will be used to predict current point cloud. The motion matrix R and T will be signaled.

### 3.4 Signalling of Motion Parameters

The motion matrix are fractional accuracy. In InterEM, they will be quantized firstly. Then, segment thresholds and quantized motion matrix (called segment thresholds and motion matrix as motion parameters) will be binarized to a bin string. For each bin, it will be coded with context.

### 3.4.1 Quantization and Dequantization of Motion Matrix

In encoder side, the motion matrix R and T will be performed quantization process to get \hat{R} and \hat{T}. For r₁₁, r₂₂ and r₃₃ component in rotation matrix R, they will firstly minus 1, then multiplied by a scale factor, lastly be round to the nearest integer. To be specific, the quantization process as follows:

$$\hat{r} = round ( ( r - 1 ) \times 65535 ) \qquad ( 3 - 2 )$$

For rest component in rotation matrix R, they will be firstly multiplied by a scale factor, then be round to the nearest integer. To be specific, the quantization process as follows:

$$\hat{r} = round ( r \times 65535 ) \qquad ( 3 - 3 )$$

For each component in translation vector T, they will be directly round to the nearest integer. To be specific, the quantization process as follows:

$$\hat{t} = round ( t ) \qquad ( 3 - 4 )$$

In decoder side, R and T will be performed dequantization process to get R′ and T′. For \hat{r}₁₁, \hat{r}₂₂ and \hat{r}₃₃ component in rotation matrix R, they will be dequantized as follows:

$${r}^{′} = \frac{\hat{r}}{65535} + 1 \qquad ( 3 - 5 )$$

For rest component in quantized rotation matrix R, the dequantization process as follows:

$${r}^{′} = \frac{\hat{r}}{65535} \qquad ( 3 - 6 )$$

For each component in quantized translation vector T, the dequantization process as follows:

$${t}^{′} = \hat{t} \qquad ( 3 - 7 )$$

### 3.4.2 Binarization of Motion Parameters

The segment thresholds and quantized motion matrix are signed integer. When they are positive integer or 0, they will be binarized using 0-th order Exp-Golomb (EGO) binarization scheme. When they are negative, they will be convert to corresponding twos complement format firstly, then the twos complement format will be regard as unsigned integer binarized using 0-th order Exp-Golomb binarization scheme. The 0-th order Exp-Golomb binarization scheme will binary an unsigned integer to a bin string.

TABLE 1
Bin string of EG0 binarization

| codeNum | Bin string |
|---|---|
| 0 | 0 |
| 1 | 100 |
| 2 | 101 |
| 3 | 11000 |
| 4 | 11001 |
| 5 | 11010 |
| 6 | 11011 |
| 7 | 1110000 |
| 8 | 1110001 |
| . . . | |

### 4. Problems

The existing designs for signaling of motion parameters have the following problems:
1. The InterEM quantize the translation vector T round to the nearest integer. However, the precision of translation vector T has an influence on motion compensation result. So how to quantize the translation vector T should be further studied.
2. In current InterEM, it directly codes the motion parameters without any prediction. However, there is correlation (information redundancy) between motion parameters of adjacent point cloud frame. So directly coding them is not optimal.
3. When binarizing motion parameters, the current InterEM regards the two's complement format of a negative value is treated as an unsigned integer and binarize the unsigned integer using a 0-th order Exp-Golomb binarization scheme. However, the binary scheme is not consistent with the distributed probability of the motion parameters. For example, when the coded number is a small negative one which has relatively high occurrence probability but its two's complement format is a large unsigned integer with a long code length. In this case, it is inefficient.

### 5. Detailed Descriptions

In this disclosure, it is proposed to improve the coding of motion parameters in point cloud inter prediction, where motion parameters include one or more of the rotation matrix, translation vector, segment thresholds. Compared to current motion parameters coding method, correlation between the motion parameters of adjacent point cloud frame is considered, thus can better remove temporal information redundancy of motion parameters. At the same time, the translation vector is quantized with more sophisticated precision control. Last, it is proposed to binarize the motion parameters according to their distribution probability.

To solve the above problems and some other problems not mentioned, methods as summarized below are disclosed. The embodiments should be considered as examples to explain the general concepts and should not be interpreted in a narrow way. Furthermore, these embodiments can be applied individually or combined in any manner.

In the following discussion, a “point cloud” may refer to a frame in the point cloud sequence.
1) To solve the first problem, one or more of the following approaches are disclosed:
   a. A motion parameter is coded in a predictive way. To be specifically, a motion parameter difference may be derived by calculating the difference between a current motion parameter and a reference motion parameter.
      i. In one example, in the case of uni-direction prediction, a reference motion parameter is equal to the motion parameter of a reference point cloud (e.g., reference frame).
      ii. Alternatively, in the case of bi-direction prediction, a reference motion parameter can be equal to one of two reference point cloud motion parameter or be equal to the fusion of two reference point cloud motion parameters.
      iii. In one example, the reference motion parameter may be a fixed value, which may be pre-defined or signaled in the bitstream.
   b. Different motion parameters can adopt different reference motion parameters.
      i. In one example, the reference motion matrix can be equal to one of two reference point cloud motion matrix.
      ii. In one example, the reference segment thresholds can be equal to the fusion of two reference point cloud segment thresholds.
      iii. In one example, reference motion matrix can be equal to the fusion of two reference point cloud motion matrix.
      iv. In one example, the reference segment thresholds can be equal to one of two reference point cloud segment thresholds.
      v. In one example, reference motion matrix can be equal to one of two reference point cloud motion matrix.
      vi. In one example, reference segment thresholds can be equal to one of two reference point cloud segment thresholds.
      vii. In one example, reference motion matrix can be equal to the fusion of two reference point cloud motion matrix.
      viii. In one example, reference segment thresholds can be equal to the fusion of two reference point cloud segment thresholds.
      ix. In one example, the above methods may be applied in the case of bi-direction prediction.
2) To solve the second problem, the following approaches are disclosed:
   a. In encoder side, round each component in translation vector down (or up) to the nearest integer.
      i. In one example, for each component in translation vector T, the quantization process as follows:

$$\hat{t} = floor ( t ) \qquad ( 5 - 1 )$$

ii. In one example, for each component in translation vector T, the quantization process as follows:

$$\hat{t} = ceil ( t ) \qquad ( 5 - 2 )$$

b. In decoder side, the reconstructed translation vector is directly equal to quantized translation vector.
   i. In one example, for each component in quantized translation vector 1, the dequantization process as follows:

$${t}^{′} = \hat{t} \qquad ( 5 - 3 )$$

c. In encoder side, each component in translation vector is multiplied by a scale factor, then is rounded to the nearest integer or is rounded down (or up) to the nearest integer.
   i. In one example, when the scale factor is 65535, for each component in translation vector T, the quantization process as follows:

$$\hat{t} = round ( t \times 65535 ) \qquad ( 5 - 4 )$$

ii. In one example, when the scale factor is 65535, for each component in translation vector T, the quantization process as follows:

$$\hat{t} = floor ( t \times 65535 ) \qquad ( 5 - 5 )$$

iii. In one example, when the scale factor is 65535, for each component in translation vector T, the quantization process as follows:

$$\hat{t} = ceil ( t \times 65535 ) \qquad ( 5 - 6 )$$

d. In decoder side, the reconstructed translation vector can be derived through quantized translation vector divided by the scale factor.
   i. The division operation may be replaced by a shifting operation.
   ii. In one example, when the scale factor is 65535, for each component in quantized translation vector 1, the dequantization process as follows:

$${t}^{′} = \frac{\hat{t}}{65535} \qquad ( 5 - 7 )$$

3) To solve the third problem, following approaches are disclosed:
   a. It is proposed that the motion parameter may be converted to an unsigned integer and the unsigned integer is coded to the bitstream.
      i. At the decoder side, the decoded unsigned integer value is then mapped to an signed value and the signed value is treated as the decoded motion parameter.
      ii. In one example, the larger the absolute value of the motion parameters, the larger the corresponding converted unsigned integer.
      iii. In one example, if motion parameters x is greater than or equal to 0, the converted unsigned integer y is equal to 2x; if motion parameters x is less than 0, the converted unsigned integer y is equal to −2x−1. Some examples are shown as Table 2.
   Table 2 an example of convert method from signed integer to unsigned integer

| | | | | | | | | | |
|---|---|---|---|---|---|---|---|---|---|
| x | 0 | −1 | 1 | −2 | 2 | −3 | 3 | −4 | . . . |
| y | 0 | 1 | 2 | 3 | 4 | 5 | 6 | 7 | |

iv. Alternatively, if motion parameters x is less than or equal to 0, the converted unsigned integer is equal to −2x; if motion parameters x is greater than 0, the converted unsigned integer is equal to 2x−1. Some examples are shown as Table 3.
Table 3 another example of convert method from signed integer to unsigned integer

| | | | | | | | | | |
|---|---|---|---|---|---|---|---|---|---|
| x | 0 | 1 | −1 | 2 | −2 | 3 | −3 | 4 | . . . |
| y | 0 | 1 | 2 | 3 | 4 | 5 | 6 | 7 | |

b. The converted unsigned integer can be binarized using variable length code.
   i. In one example, the converted unsigned integer can be binarized using EGk binarization method (where k is equal to 0, 1 . . . ).
   ii. Alternatively, the converted unsigned integer can be binarized using Unary binarization method. Some examples are shown as Table 4.

TABLE 4
Bin string of unary binarization

| codeNum | Bin string |
|---|---|
| 0 | 0 |
| 1 | 10 |
| 2 | 110 |
| 3 | 1110 |
| 4 | 11110 |
| 5 | 111110 |
| 6 | 1111110 |
| 7 | 11111110 |
| . . . | |

c. In one example, the motion parameter may be binarized with a signed exponential Golomb code.
d. In one example, the motion parameter may be binarized with a signed unary code.
e. In one example, the motion parameter may be represented as a sign and an absolute value.
   i. In one example, the sign may be conditionally coded.
      (1) E.g., it is not coded if the absolute value is equal to 0.
   ii. In one example, the sign may be coded as a flag.
   iii. In one example, the absolute value may be binarized with fixed length coding/unary coding/exponential Golomb coding/rice coding, etc.
f. The parameter/value/integers/code disclosed above may be coded with at least one context in arithmetic coding, or be coded in a bypass mode.

### 6. Embodiments

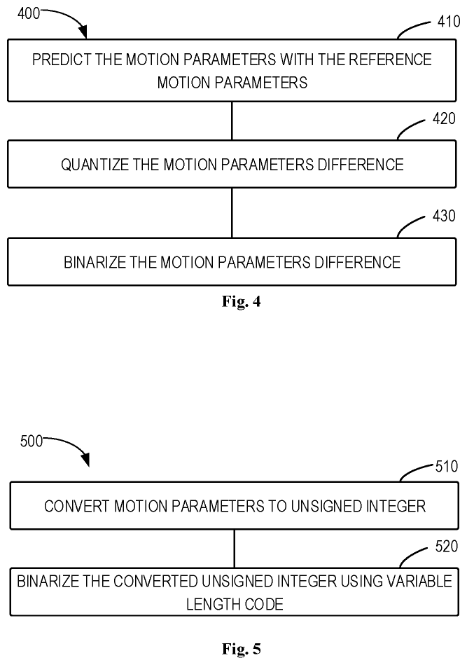

An example of the coding flow 400 for the improved motion parameters coding in point cloud inter prediction is depicted in FIG. 4. At block 410, the motion parameters are predicted with the reference motion parameters. At block 420, the motion parameters difference are quantized. At block 430, the motion parameters difference are binarized. There step above can be used separately. Another example of the coding flow 500 for the improved motion parameters coding using the binarization method alone is depicted in FIG. 5. At block 510, motion parameters are converted to unsigned integer. At block 520, the converted unsigned integer is binarized using variable length code.

The embodiments of the present disclosure are related to motion information coding for point cloud coding. As used herein, the term “point cloud sequence” may refer to a sequence of one or more point clouds. The term “frame” may refer to a point cloud in a point cloud sequence. The term “point cloud” may refer to a frame in the point cloud sequence.

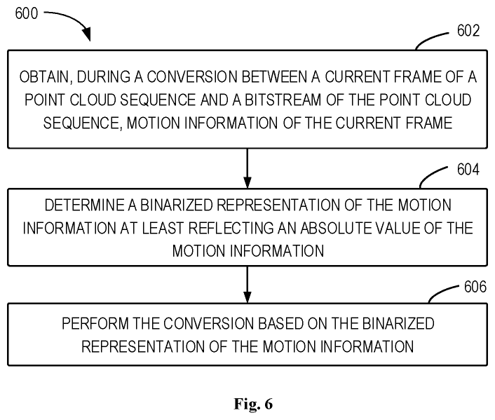

FIG. 6 illustrates a flowchart of method 600 for point cloud coding in accordance with some embodiments of the present disclosure. The method 600 may be implemented during a conversion between a current frame of a point cloud sequence and a bitstream of the point cloud sequence. As shown in FIG. 6, the method 600 starts at block 602, where motion information of the current frame is obtained. At block 604, a binarized representation of the motion information is determined. The binarized representation at least reflecting an absolute value of the motion information.

By determining a binarized representation of the motion information to reflect the absolute value of the motion information, the motion information may be binarized according to the distribution probability. In this way, the coding efficiency can be improved.

At block 606, a conversion between the current frame of the point cloud sequence and the bitstream of the point cloud sequence is performed based on the binarized representation of the motion information. In some embodiments the conversion may include encoding the current frame into the bitstream. Alternatively, or in addition, the conversion may include decoding the current frame from the bitstream.

The method 600 binarized the motion information according to its distribution probability. Compared with the conventional solution where the negative motion information is coded with a complement format, the proposed binarized representation of the motion information can reflect the absolute value of the motion information, and thus be consistent with the distribution probability of the motion information. In this way, the coding length can be reduced, and thus the coding efficiency can be improved.

In some embodiments, at block 604, a binarized value of the motion information may be determined based on the absolute value of the motion information. The binarized representation may be determined at least based on the binarized value.

In some embodiments, to determine the binarized representation at least based on the binarized value, it may determine whether the absolute value of the motion information meets a sign coding criterion. If the absolute value meets the sign coding criterion, a coded sign of the motion information may be determined based on a sign of the motion information. For example, the sign may be coded as a flag. The binarized representation may be determined by incorporating the coded sign and the binarized value. Otherwise, if the absolute value fails to meet the sign coding criterion, the binarized representation may be determined by incorporating the binarized value.

In some embodiments, the sign coding criterion comprises that the absolute value is greater than zero. For example, if the absolute value is zero, then the sign coding criterion is not met. In other words, the sign will not be coded if the absolute value is equal to 0.

In some embodiments, the binarized value of the motion information is determined by coding the absolute value of the motion information with one of the following: a fixed length coding tool, a unary coding tool, an exponential Golomb coding tool, a ride coding tool, or any other suitable coding tool or coding method. Some examples of binarized values coded with unary coding tool are shown in Table 4.

Alternatively, or in addition, in some embodiments, at block 604, an unsigned coded representation of the motion information may be determined. The unsigned coded representation may be included in the bitstream. The binarized representation of the motion information may be determined by binarizing the unsigned coded representation. For example, if a first absolute value of first motion information is greater than a second absolute value of second motion information, a first unsigned coded representation of the first motion information is greater than a second unsigned coded representation of the second motion information.

In some embodiments, a value of the motion information is compared with a threshold. The threshold may be zero or other suitable value. The unsigned coded representation may be determined by using a metric determined based on the comparison. For example, if the value of the motion information is greater than or equal to the threshold, the metric is determined to be two times the value. Otherwise, if the value of the motion information is less than the threshold, the metric is determined to be minus two times the value minus one. Examples of unsigned coded representation using these two metrics are illustrated in Table 2.

Alternatively, in some embodiments, if the value of the motion information is less than or equal to the threshold, the metric is determined to be minus two times the value. Alternatively, in some embodiments, if the value of the motion information is greater than the threshold, the metric is determined to be two times the value minus one. Examples of unsigned coded representation using these two metrics are illustrated in Table 3.

In some embodiments, a corresponding signed value of the unsigned coded representation of the motion information is determined. The corresponding signed value may be treated as decoded motion information during the conversion.

In some embodiments, the unsigned coded representation is binarized by using one of the following: a variable length coding tool, an exponential Golomb coding tool, a unary coding tool, or any other suitable coding tool or coding method. For example, the exponential Golomb coding tool may be a k-th order exponential Golomb (EGk) coding tool, k being a positive integer.

Alternatively, or in addition, at block 604, the binarized representation of the motion information may be determined by binarizing a value of the motion information. For example, the value of the motion information may be binarized by using one of the following: a signed exponential Golomb coding tool, a signed unary coding tool, or any other suitable coding tool or coding method.

In some embodiments, the motion information may comprise a motion parameter value. Alternatively, or in addition, in some embodiments, the motion information may comprise a motion parameter difference. That is, the motion information or the motion parameter is coded in a predictive way. For example, the motion parameter difference may be determined based on the motion parameter value and a reference motion parameter value. By using the motion parameter difference as the motion information, the motion information can be coded with prediction. In addition, taking the correlation between motion parameters of adjacent point cloud frame into consideration can remove temporal information redundancy of motion information.

In some embodiments, the reference motion parameter value comprises a motion parameter value of a reference point cloud or a reference frame for a uni-direction prediction. In other words, in the case of uni-direction prediction, a reference motion parameter is equal to the motion parameter of a reference point cloud (e.g., reference frame).

In some embodiments, the reference motion parameter value comprises at least one of two motion parameter values of two reference point clouds for a bi-direction prediction. In other words, in the case of bi-direction prediction, a reference motion parameter may be equal to one of two reference point cloud motion parameter or be equal to the fusion of two reference point cloud motion parameters.

Alternatively, or in addition, in some embodiments, the reference motion parameter value is a fixed value. For example, the fixed value may be pre-defined or included in the bitstream.

In some embodiments, a first reference motion parameter is associated with a first motion parameter, and a second reference motion parameter different from the first reference motion parameter is associated with a second motion parameter different from the first motion parameter. That is, different motion parameters can adopt different reference motion parameters.

In some embodiments, the reference motion parameter value comprises one of two reference point cloud motion matrixes, or comprises a fusion of the two reference point cloud motion matrixes. For example, the reference motion matrix may be equal to one of two reference point cloud motion matrix. Alternatively, the reference motion matrix may be equal to the fusion of two reference point cloud motion matrixes.

Alternatively, or in addition, in some embodiments, the reference motion parameter value comprises one of two reference point cloud segment thresholds, or comprises a fusion of the two reference point cloud segment thresholds. For example, the reference segment threshold may be equal to one of two reference point cloud segment thresholds. Alternatively, the reference segment threshold may be equal to the fusion of two reference point cloud segment thresholds.

In some embodiments, the method can be applied in a bi-direction prediction or a uni-direction prediction.

In some embodiments, the motion information comprises a quantized translation vector. For example, the quantized translation vector may be quantized by rounding a component in the translation vector down to or up to a nearest integer. In this way, the translation vector can be quantized with more sophisticated precision control.

In some embodiments, the component is rounded by using a flooring metric rounding the component down to the nearest integer, such as floor(t). Alternatively, the component may be rounded by using a ceiling metric rounding the component up to the nearest integer, such as ceil(t). Alternatively, the component may be rounded by using a rounding metric rounding the component to the nearest integer, such as round(t).

In some embodiments, the quantized translation vector is equal to a reconstructed or dequantized translation vector.

Alternatively, or in addition, in some embodiments, the quantized translation vector is quantized by multiplying a component in the translation vector by a scaling factor and rounding the multiplied component down to or up to a nearest integer. By way of example, the scaling factor may be 65535. For example, the multiplied component may be rounded by using a flooring metric rounding the multiplied component down to the nearest integer. For another example, the multiplied component may be rounded by using a ceiling metric rounding the multiplied component up to the nearest integer. For a further example, the multiplied component may be rounded by using a rounding metric rounding the multiplied component to the nearest integer.

In some embodiments, a reconstructed or dequantized translation vector is obtained by dividing the quantized translation vector by a scaling factor. Alternatively, the reconstructed or dequantized translation vector may be obtained by shifting the quantized translation vector by a shifting factor associated with the scaling factor.

In some embodiments, the quantization of the translation vector is performed at an encoder side. The reconstruction or dequantization of the quantized translation vector may be performed at a decoder side.

In some embodiments, information, parameter, value, integer or code associated with the motion information is coded with at least one context in arithmetic coding, or coded in a bypass mode. In other words, the parameter, value, integers, or code disclosed above may be coded with at least one context in arithmetic coding, or coded in a bypass mode.

In some embodiments, a bitstream of a point cloud sequence may be stored in a non-transitory computer-readable recording medium. The bitstream of the point cloud sequence can be generated by a method performed by a point cloud processing apparatus. According to the method, motion information of a current frame of the point cloud sequence may be obtained. A binarized representation of the motion information may be determined. The binarized representation at least reflects an absolute value of the motion information. A bitstream of the current frame may be generated based on the binarized representation of the motion information.

In some embodiments, motion information of a current frame of a point cloud sequence is obtained. A binarized representation of the motion information may be determined. The binarized representation at least reflects an absolute value of the motion information. A bitstream of the current frame may be generated based on the binarized representation of the motion information. The bitstream may be stored in a non-transitory computer-readable recording medium.

Implementations of the present disclosure can be described in view of the following clauses, the features of which can be combined in any reasonable manner.

Clause 1. A method for point cloud coding, comprising: obtaining, during a conversion between a current frame of a point cloud sequence and a bitstream of the point cloud sequence, motion information of the current frame; determining a binarized representation of the motion information, the binarized representation at least reflecting an absolute value of the motion information; and performing the conversion based on the binarized representation of the motion information.

Clause 2. The method of clause 1, wherein determining the binarized representation of the motion information comprises: determining a binarized value of the motion information based on the absolute value of the motion information; and determining the binarized representation at least based on the binarized value.

Clause 3. The method of clause 2, wherein determining the binarized representation at least based on the binarized value comprises: in accordance with a determination that the absolute value meets a sign coding criterion, determining a coded sign of the motion information based on a sign of the motion information; and determining the binarized representation by incorporating the coded sign and the binarized value; and in accordance with a determination that the absolute value fails to meet the sign coding criterion, determining the binarized representation by incorporating the binarized value.

Clause 4. The method of clause 3, wherein the sign coding criterion comprises that the absolute value is greater than zero.

Clause 5. The method of clause 3 or clause 4, wherein determining the coded sign comprises: coding the sign as a flag.

Clause 6. The method of any of clauses 2-5, wherein determining the binarized value of the motion information comprises: determining the binarized value by coding the absolute value of the motion information with one of the following: a fixed length coding tool, a unary coding tool, an exponential Golomb coding tool, or a ride coding tool.

Clause 7. The method of clause 1, wherein determining the binarized representation of the motion information comprises: determining an unsigned coded representation of the motion information, the unsigned coded representation being included in the bitstream; and determining the binarized representation of the motion information by binarizing the unsigned coded representation.

Clause 8. The method of clause 7, wherein if a first absolute value of first motion information is greater than a second absolute value of second motion information, a first unsigned coded representation of the first motion information is greater than a second unsigned coded representation of the second motion information.

Clause 9. The method of clause 7 or clause 8, wherein determining the unsigned coded representation of the motion information comprises: comparing a value of the motion information with a threshold; and determining the unsigned coded representation by using a metric determined based on the comparison.

Clause 10. The method of clause 9, wherein determining the metric based on the comparison comprises: in accordance with a determination that the value of the motion information is greater than or equal to the threshold, determining the metric to be two times the value; and in accordance with a determination that the value of the motion information is less than the threshold, determining the metric to be minus two times the value minus one.

Clause 11. The method of clause 9, wherein determining the metric based on the comparison comprises: in accordance with a determination that the value of the motion information is less than or equal to the threshold, determining the metric to be minus two times the value; and in accordance with a determination that the value of the motion information is greater than the threshold, determining the metric to be two times the value minus one.

Clause 12. The method of any of clauses 9-11, wherein the threshold is zero.

Clause 13. The method of any of clauses 7-12, further comprising: determining a corresponding signed value of the unsigned coded representation of the motion information, the corresponding signed value being decoded motion information during the conversion.

Clause 14. The method of any of clauses 7-13, wherein the unsigned coded representation is binarized by using one of the following: a variable length coding tool, an exponential Golomb coding tool, or a unary coding tool.

Clause 15. The method of clause 14, wherein the exponential Golomb coding tool comprises a k-th order exponential Golomb (EGk) coding tool, k being a positive integer.

Clause 16. The method of clause 1, wherein determining the binarized representation of the motion information comprises: determining the binarized representation of the motion information by binarizing a value of the motion information.

Clause 17. The method of clause 16, wherein the value of the motion information is binarized by using one of the following: a signed exponential Golomb coding tool, or a signed unary coding tool.

Clause 18. The method of any of clauses 1-17, wherein the motion information comprises at least one of: a motion parameter value, or a motion parameter difference.

Clause 19. The method of clause 18, further comprising: determining the motion parameter difference based on the motion parameter value and a reference motion parameter value.

Clause 20. The method of clause 19, wherein the reference motion parameter value comprises a motion parameter value of a reference point cloud or a reference frame for a uni-direction prediction.

Clause 21. The method of clause 19, wherein the reference motion parameter value comprises at least one of two motion parameter values of two reference point clouds for a bi-direction prediction.

Clause 22. The method of any of clauses 19-21, wherein the reference motion parameter value is a fixed value, the fixed value being pre-defined or included in the bitstream.

Clause 23. The method of any of clauses 19-22, wherein a first reference motion parameter is associated with a first motion parameter, and a second reference motion parameter different from the first reference motion parameter is associated with a second motion parameter different from the first motion parameter.

Clause 24. The method of any of clauses 19-23, wherein the reference motion parameter value comprises one of two reference point cloud motion matrixes, or comprises a fusion of the two reference point cloud motion matrixes.

Clause 25. The method of any of clauses 19-24, wherein the reference motion parameter value comprises one of two reference point cloud segment thresholds, or comprises a fusion of the two reference point cloud segment thresholds.

Clause 26. The method of any of clauses 19-25, wherein the method is applied in a bi-direction prediction or a uni-direction prediction.

Clause 27. The method of any of clauses 1-26, wherein the motion information comprises a quantized translation vector.

Clause 28. The method of clause 27, wherein the quantized translation vector is quantized by: rounding a component in the translation vector down to or up to a nearest integer.

Clause 29. The method of clause 28, wherein the component is rounded by using one of the following: a flooring metric rounding the component down to the nearest integer, a ceiling metric rounding the component up to the nearest integer, or a rounding metric rounding the component to the nearest integer.

Clause 30. The method of clause 28 or clause 29, wherein the quantized translation vector is equal to a reconstructed or dequantized translation vector.

Clause 31. The method of clause 27, wherein the quantized translation vector is quantized by multiplying a component in the translation vector by a scaling factor and rounding the multiplied component down to or up to a nearest integer.

Clause 32. The method of clause 31, wherein the multiplied component is rounded by using one of the following: a flooring metric rounding the multiplied component down to the nearest integer, a ceiling metric rounding the multiplied component up to the nearest integer, or a rounding metric rounding the multiplied component to the nearest integer.

Clause 33. The method of clause 31 or clause 32, further comprising: obtaining a reconstructed or dequantized translation vector by one of the following: dividing the quantized translation vector by a scaling factor; or shifting the quantized translation vector by a shifting factor associated with the scaling factor.

Clause 34. The method of any of clauses 31-33, wherein the scaling factor is 65535.

Clause 35. The method of any of clauses 27-34, wherein the quantization of the translation vector is performed at an encoder side.

Clause 36. The method of clause 30 or clause 33, wherein the reconstruction or dequantization of the quantized translation vector is performed at a decoder side.

Clause 37. The method of any of clauses 1-36, wherein information, parameter, value, integer or code associated with the motion information is coded with at least one context in arithmetic coding, or coded in a bypass mode.

Clause 38. The method of any of clauses 1-37, wherein the conversion includes encoding the current frame into the bitstream.

Clause 39. The method of any of clauses 1-37, wherein the conversion includes decoding the current frame from the bitstream.

Clause 40. An apparatus for processing video data comprising a processor and a non-transitory memory with instructions thereon, wherein the instructions upon execution by the processor, cause the processor to perform a method in accordance with any of Clauses 1-39.

Clause 41. A non-transitory computer-readable storage medium storing instructions that cause a processor to perform a method in accordance with any of Clauses 1-39.

Clause 42. A non-transitory computer-readable recording medium storing a bitstream of a point cloud sequence which is generated by a method performed by a point cloud processing apparatus, wherein the method comprises: obtaining motion information of a current frame of a the point cloud sequence; determining a binarized representation of the motion information, the binarized representation at least reflecting an absolute value of the motion information; and generating the bitstream based on the binarized representation of the motion information.

Clause 43. A method for storing a bitstream of a point cloud sequence, comprising: obtaining motion information of a current frame of a the point cloud sequence; determining a binarized representation of the motion information, the binarized representation at least reflecting an absolute value of the motion information; generating the bitstream based on the binarized representation of the motion information; and storing the bitstream in a non-transitory computer-readable recording medium.

### Example Device

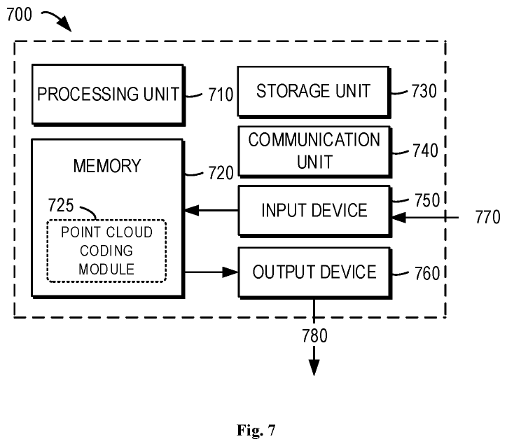

FIG. 7 illustrates a block diagram of a computing device 700 in which various embodiments of the present disclosure can be implemented. The computing device 700 may be implemented as or included in the source device 110 (or the GPCC encoder 116 or 200) or the destination device 120 (or the GPCC decoder 126 or 300).

It would be appreciated that the computing device 700 shown in FIG. 7 is merely for purpose of illustration, without suggesting any limitation to the functions and scopes of the embodiments of the present disclosure in any manner.

As shown in FIG. 7, the computing device 700 includes a general-purpose computing device 700. The computing device 700 may at least comprise one or more processors or processing units 710, a memory 720, a storage unit 730, one or more communication units 740, one or more input devices 750, and one or more output devices 760.

In some embodiments, the computing device 700 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 700 can support any type of interface to a user (such as “wearable” circuitry and the like).

The processing unit 710 may be a physical or virtual processor and can implement various processes based on programs stored in the memory 720. In a multi-processor system, multiple processing units execute computer executable instructions in parallel so as to improve the parallel processing capability of the computing device 700. The processing unit 710 may also be referred to as a central processing unit (CPU), a microprocessor, a controller or a microcontroller.

The computing device 700 typically includes various computer storage medium. Such medium can be any medium accessible by the computing device 700, including, but not limited to, volatile and non-volatile medium, or detachable and non-detachable medium. The memory 720 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 730 may be any detachable or non-detachable medium and may include a machine-readable medium such as a memory, flash memory drive, magnetic disk or another other media, which can be used for storing information and/or data and can be accessed in the computing device 700.

The computing device 700 may further include additional detachable/non-detachable, volatile/non-volatile memory medium. Although not shown in FIG. 7, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 740 communicates with a further computing device via the communication medium. In addition, the functions of the components in the computing device 700 can be implemented by a single computing cluster or multiple computing machines that can communicate via communication connections. Therefore, the computing device 700 can operate in a networked environment using a logical connection with one or more other servers, networked personal computers (PCs) or further general network nodes.

The input device 750 may be one or more of a variety of input devices, such as a mouse, keyboard, tracking ball, voice-input device, and the like. The output device 760 may be one or more of a variety of output devices, such as a display, loudspeaker, printer, and the like. By means of the communication unit 740, the computing device 700 can further communicate with one or more external devices (not shown) such as the storage devices and display device, with one or more devices enabling the user to interact with the computing device 700, or any devices (such as a network card, a modem and the like) enabling the computing device 700 to communicate with one or more other computing devices, if required. Such communication can be performed via input/output (I/O) interfaces (not shown).

In some embodiments, instead of being integrated in a single device, some or all components of the computing device 700 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 700 may be used to implement point cloud encoding/decoding in embodiments of the present disclosure. The memory 720 may include one or more point cloud coding modules 725 having one or more program instructions. These modules are accessible and executable by the processing unit 710 to perform the functionalities of the various embodiments described herein.

In the example embodiments of performing point cloud encoding, the input device 750 may receive point cloud data as an input 770 to be encoded. The point cloud data may be processed, for example, by the point cloud coding module 725, to generate an encoded bitstream. The encoded bitstream may be provided via the output device 760 as an output 780.

In the example embodiments of performing point cloud decoding, the input device 750 may receive an encoded bitstream as the input 770. The encoded bitstream may be processed, for example, by the point cloud coding module 725, to generate decoded point cloud data. The decoded point cloud data may be provided via the output device 760 as the output 780.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for point cloud coding, comprising:
obtaining, during a conversion between a current frame of a point cloud sequence and a bitstream of the point cloud sequence, motion information of the current frame;
determining a binarized representation of the motion information, the binarized representation at least reflecting an absolute value of the motion information; and
performing the conversion based on the binarized representation of the motion information.

2. The method of claim 1, wherein determining the binarized representation of the motion information comprises:
determining a binarized value of the motion information based on the absolute value of the motion information; and
determining the binarized representation at least based on the binarized value.

3. The method of claim 2, wherein determining the binarized representation at least based on the binarized value comprises:
in accordance with a determination that the absolute value of the motion information meets a sign coding criterion,
determining a coded sign of the motion information based on a sign of the motion information; and
determining the binarized representation by incorporating the coded sign and the binarized value; and
in accordance with a determination that the absolute value of the motion information fails to meet the sign coding criterion, determining the binarized representation by incorporating the binarized value,
wherein the sign coding criterion comprises that the absolute value is greater than zero,
wherein determining the coded sign comprises: coding the sign as a flag.

4. The method of claim 2, wherein determining the binarized value of the motion information comprises:
determining the binarized value by coding the absolute value of the motion information with one of: a fixed length coding tool, a unary coding tool, an exponential Golomb coding tool, or a rice coding tool.

5. The method of claim 1, wherein determining the binarized representation of the motion information comprises:
determining an unsigned coded representation of the motion information, the unsigned coded representation being included in the bitstream; and
determining the binarized representation of the motion information by binarizing the unsigned coded representation,
wherein if a first absolute value of first motion information is greater than a second absolute value of second motion information, a first unsigned coded representation of the first motion information is greater than a second unsigned coded representation of the second motion information, or
wherein determining the unsigned coded representation of the motion information comprises:
comparing a value of the motion information with a threshold; and
determining the unsigned coded representation by using a metric determined based on the comparison.

6. The method of claim 5, wherein determining the metric based on the comparison comprises:
in accordance with a determination that the value of the motion information is greater than or equal to the threshold, determining the metric to be two times the value; and
in accordance with a determination that the value of the motion information is less than the threshold, determining the metric to be minus two times the value minus one, or
wherein determining the metric based on the comparison comprises:
in accordance with a determination that the value of the motion information is less than or equal to the threshold, determining the metric to be minus two times the value; and
in accordance with a determination that the value of the motion information is greater than the threshold, determining the metric to be two times the value minus one.

7. The method of claim 5, further comprising:
determining a corresponding signed value of the unsigned coded representation of the motion information, the corresponding signed value being decoded motion information during the conversion,
wherein the unsigned coded representation is binarized by using one of: a variable length coding tool, an exponential Golomb coding tool, or a unary coding tool,
wherein the exponential Golomb coding tool comprises a k-th order exponential Golomb (EGk) coding tool, k being a positive integer.

8. The method of claim 1, wherein determining the binarized representation of the motion information comprises:
determining the binarized representation of the motion information by binarizing a value of the motion information,
wherein the value of the motion information is binarized by using one of: a signed exponential Golomb coding tool, or a signed unary coding tool.

9. The method of claim 1, wherein the motion information comprises at least one of: a motion parameter value, or a motion parameter difference,
wherein the method further comprises: determining the motion parameter difference based on the motion parameter value and a reference motion parameter value,
wherein the reference motion parameter value comprises a motion parameter value of a reference point cloud or a reference frame for a uni-direction pre-diction, or
wherein the reference motion parameter value comprises at least one of two motion parameter values of two reference point clouds for a bi-direction prediction.

10. The method of claim 9, wherein the reference motion parameter value is a fixed value, the fixed value being pre-defined or included in the bitstream,
wherein a first reference motion parameter is associated with a first motion parameter, and a second reference motion parameter different from the first reference motion parameter is associated with a second motion parameter different from the first motion parameter,
wherein the reference motion parameter value comprises one of two reference point cloud motion matrixes, or comprises a fusion of the two reference point cloud motion matrixes,
wherein the reference motion parameter value comprises one of two reference point cloud segment thresholds, or comprises a fusion of the two reference point cloud segment thresholds, or
wherein the method is applied in a bi-direction prediction or a uni-direction prediction.

11. The method of claim 1, wherein the motion information comprises a quantized translation vector,
wherein the quantized translation vector is quantized by: rounding a component in the translation vector down to or up to a nearest integer, or
wherein the component is rounded by using one of: a flooring metric rounding the component down to the nearest integer, a ceiling metric rounding the component up to the nearest integer, or a rounding metric rounding the component to the nearest integer,
wherein the quantized translation vector is equal to a reconstructed or dequantized translation vector.

12. The method of claim 11, wherein the quantized translation vector is quantized by multiplying a component in the translation vector by a scaling factor and rounding the multi-plied component down to or up to a nearest integer,
wherein the multiplied component is rounded by using one of: a flooring metric rounding the multiplied component down to the nearest integer, a ceiling metric rounding the multiplied component up to the nearest integer, or a rounding metric rounding the multiplied component to the nearest integer.

13. The method of claim 12, further comprising:
obtaining a reconstructed or dequantized translation vector by one of the following:
dividing the quantized translation vector by a scaling factor; or
shifting the quantized translation vector by a shifting factor associated with the scaling factor, wherein the scaling factor is 65535,
wherein the reconstruction or dequantization of the quantized translation vector is performed at a decoder side.

14. The method of claim 11, wherein the quantization of the translation vector is performed at an encoder side.

15. The method of claim 1, wherein information, parameter, value, integer or code associated with the motion information is coded with at least one context in arithmetic coding, or coded in a bypass mode.

16. The method of claim 1, wherein the conversion includes encoding the current frame into the bitstream.

17. The method of claim 1, wherein the conversion includes decoding the current frame from the bitstream.

18. An apparatus for processing point cloud data comprising a processor and a non-transitory memory with instructions thereon, wherein the instructions upon execution by the processor, cause the processor to:
obtain, during a conversion between a current frame of a point cloud sequence and a bitstream of the point cloud sequence, motion information of the current frame;
determine a binarized representation of the motion information, the binarized representation at least reflecting an absolute value of the motion information; and
perform the conversion based on the binarized representation of the motion information.

19. A non-transitory computer-readable storage medium storing instructions that cause a processor to perform a method performed by a point cloud data processing apparatus, wherein the method comprises:
obtaining, during a conversion between a current frame of a point cloud sequence and a bitstream of the point cloud sequence, motion information of the current frame;
determining a binarized representation of the motion information, the binarized representation at least reflecting an absolute value of the motion information; and
performing the conversion based on the binarized representation of the motion information.

20. A non-transitory computer-readable recording medium storing a bitstream of a point cloud sequence which is generated by a method performed by a point cloud processing apparatus, wherein the method comprises:
obtaining motion information of a current frame of the point cloud sequence;
determining a binarized representation of the motion information, the binarized representation at least reflecting an absolute value of the motion information; and
generating the bitstream based on the binarized representation of the motion information.
